(19) United States
(12) Patent Application Publication
(10) Pub. No.: US 2013/0091545 A1
(43) Pub. Date: Apr. 11, 2013

(54) DELIVERY OF CUSTOMIZED CONTENT FOR UNIQUELY IDENTIFIED MEMORY DEVICES

(71) Applicants: John Macdonald, Terre Haute, IN (US); Brad Kelly, Terre Haute, IN (US); Christian Dankl, Greenwich, CT (US); Spiros Rally, Flushing, NY (US)

(72) Inventors: John Macdonald, Terre Haute, IN (US); Brad Kelly, Terre Haute, IN (US); Christian Dankl, Greenwich, CT (US); Spiros Rally, Flushing, NY (US)

(73) Assignees: SONY DADC US INC., Terre Haute, IN (US); SONY CORPORATION

(21) Appl. No.: 13/331,919

(22) Filed: Dec. 20, 2011

Related U.S. Application Data
(60) Provisional application No. 61/545,435, filed on Oct. 10, 2011.

(51) Int. Cl. G06F 12/14

(52) U.S. Cl. 726/2

(57) ABSTRACT

In particular embodiments, customized content is determined and provided to a user based on a unique identifier stored on a memory device. In one embodiment, a method of delivering content can include: accessing a unique identifier from a memory device that is removably coupled to a computing device, where the memory device includes the unique identifier and preloaded content; using the unique identifier to determine personalized information about a user of the memory device; authenticating the memory device by using the unique identifier from the memory device; determining customized content for the user if the memory device is authenticated, where the customized content is based on the unique identifier; and providing the customized content for presentation to the user along with the preloaded content and the personalized information.

### CROSS REFERENCES TO RELATED APPLICATIONS

This application claims priority from U.S. Provisional Patent Application Ser. No. 61/545,435, entitled “DELIVERY OF CUSTOMIZED CONTENT FOR UNIQUELY SERIALIZED ONE-TIME PROGRAMMABLE MEMORY DEVICES,” Attorney Docket No. 020699-108200US, filed on Oct. 10, 2011, which is hereby incorporated by reference as if set forth in full in this application for all purposes.

### BACKGROUND

Consumers are migrating to newer electronic devices (e.g., notebooks, tablets, mobile, personal media devices, etc.) which may not support disc media. These trends, together with the proliferation of broadband, have changed the way in which consumers interact with media. Content publishers, agencies, healthcare companies, financial services, and others, are seeking new methods of reaching their customers, as this cultural shift continues to grow. Content owners are shifting to reach their customers through online and on-demand broadband delivery channels, as well as via media devices.

### SUMMARY

In particular embodiments, customized content is determined and provided to a user based on a unique identifier stored on a memory device. In one embodiment, a method of delivering content can include: accessing a unique identifier from a memory device that is removably coupled to a computing device, where the memory device includes the unique identifier and preloaded content; using the unique identifier to determine personalized information about a user of the memory device; authenticating the memory device by using the unique identifier from the memory device; determining customized content for the user if the memory device is authenticated, where the customized content is based on the unique identifier; and providing the customized content for presentation to the user along with the preloaded content and the personalized information.

A further understanding of the nature and the advantages of particular embodiments disclosed herein may be realized by reference of the remaining portions of the specification and the attached drawings.

### BRIEF DESCRIPTION OF THE DRAWINGS

FIG. 1 depicts an example memory device distribution and content management system.

FIG. 2 depicts an example computing device and user interface for authentication arrangement.

FIG. 3 depicts an example data flow to deliver customized content.

FIG. 4 is a flow diagram of an example method of delivering customized content.

FIG. 5 is a first example interface presentation of customized content with preloaded content and personalized information.

FIG. 6 is a second example interface presentation of customized content with preloaded content and personalized information.

FIG. 7 is a third example interface presentation of customized content with preloaded content and personalized information.

FIG. 8 is an example memory device physical shell.

### DETAILED DESCRIPTION OF EMBODIMENTS

Particular embodiments include methods, apparatuses, and infrastructure systems used to authenticate and deliver customized content for uniquely identify memory devices. For example, such memory devices can include one-time programmable (OTP) memory cards, flash memory devices and/or other types of volatile (e.g., static random access memory (SRAM), dynamic RAM (DRAM), etc.) and/or nonvolatile memory (e.g., electrically erasable programmable read-only memory (EEPROM), resistive RAM (RRAM), etc.). In one example, the memory device may be a universal serial bus (USB) based memory device that can be removably coupled to a computing device for access of content stored on the memory device.

As described herein, applications using flash media devices may utilize unique identification for the delivery of unique, variable and personalized content, messaging, and/or offers. Particular embodiments can allow for the delivery of customized content and personalization to consumers using a memory device in their personal computing and handheld devices.

In one particular example, the customization of content may be delivered using OTP and/or flash memory devices. An OTP memory, or any other suitable memory, device can permit the mass duplication of program content onto the device. For example, the program content on these devices can be substantially permanent and non-erasable. However, since each device can be uniquely identified, this unique identifier can be combined with coding methods, web-services authentication, and content management systems to deliver targeted and specific information, or to provide secure access to a user or recipient of the memory device.

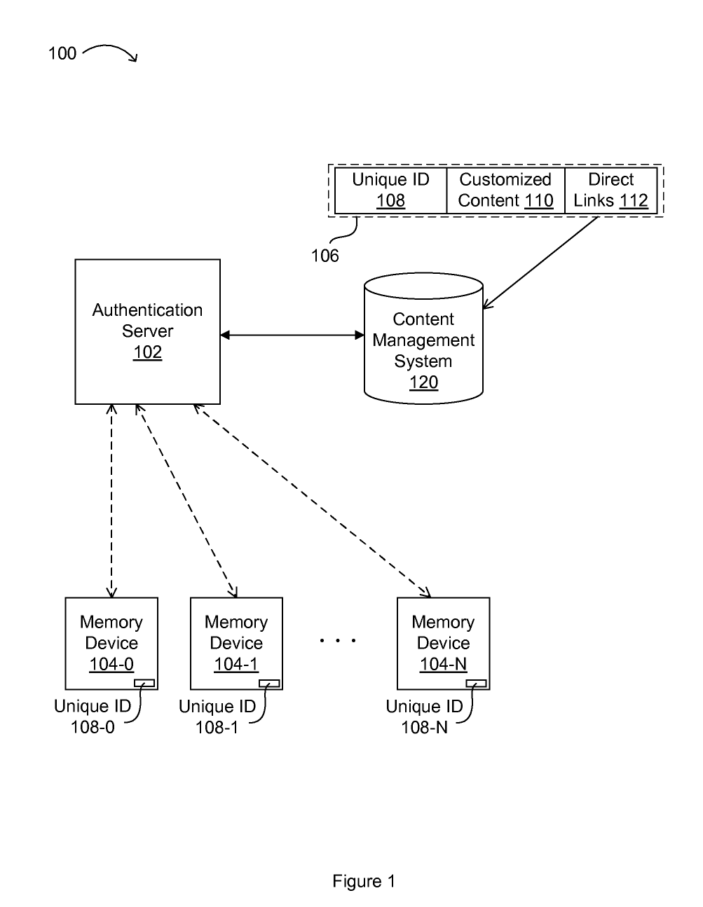

Referring now to FIG. 1, shown is an example memory device distribution and content management system 100. Any number of memory devices 104 (e.g., 104-0, 104-1, . . . 104-N) may be distributed. Each memory device 104 may include a unique identifier (ID) 108 (e.g., 108-0, 108-1, . . . 108-N). Further, unique identifiers 108 may be chosen such that various personalized information about the user, market segmentation information, or any other suitable personalized, market, or offer based information, may be encoded therein.

Authentication server 102 can essentially track distributed memory devices 104 by use of entries 106. For example, entries 106 may be stored in a content management system or database 120 that is either separate from (as shown), or included within authentication server 102. Each entry 106 can include various information used to determine customized content corresponding to that unique identifier, as well as information to validate or authenticate a memory device 104 and/or a user of the content on memory device 104. For example, each entry 106 can include unique identifier 108, customized content 110, and direct links 112.

Customized content 110 can be direct content information, or may point to another location (e.g., within content management system 120) that may store information customized to that unique identifier 108. Direct links 112 may also include uniform resource locators (URLs) that can be clicked on by a user in order to access customized information (e.g., from a partner website). Any other suitable customized content, personalized information, identifiers, permissions and/or restriction parameters can be stored in entry 106 of content management system 120, such as other unique identifiers, geographic region restrictions, a number of authorized machines, a duration of authorization, an account termination date, to name only a few.

Memory device 104 can include flash memory (e.g., 128 MB), which can be OTP and/or flash, and may be contained within cards or devices for USB connections. Personalization and a segment group offer may be identified and integrated into a standardized template. This variable content can be driven by unique identifier 108 from the memory device 104. Unique identifier 108 can be validated and authenticated in order for the user to access customized content. In addition, unique identifier 108 may be applied to each memory device 104 during the manufacturing process and/or during subsequent programming, in order to enable the delivery of personalized and unique content and information via a computing device. Further, a URL link to the segment offer may be dynamically updated based on unique identifier 108.

Thus for example, unique identifier 108 can include a unique encoded serial number on each memory device 104. The memory devices may also be entered into content management system or database 120 and tracked through the supply chain. For example, 10,000 memory devices may be designated as a certain range of unique identifiers which are treated a certain way, and the next 100,000 memory devices off the line may be designated as a different range of unique identifiers and are treated in a different way. In this fashion, many retail applications, in addition to memory device distribution control, may benefit from knowledge as to where a particular memory device 104 was sold or otherwise acquired.

In some cases, partitions on memory device 104 can allow for storage of content from a server or other device accessible via the Internet. For example, some data can be included on memory device 104 as preloaded content, and then the user could later download additional information that could be stored on memory device 104. Unique identifier 108 can be assigned at the same time as the program or preloaded content is written to memory device 104, or later in some cases. Such unique identifiers 108 can be chosen to provide intelligence, such as related to personalization or segmentation codes, etc., as opposed to strictly being hardcoded serialized identifiers.

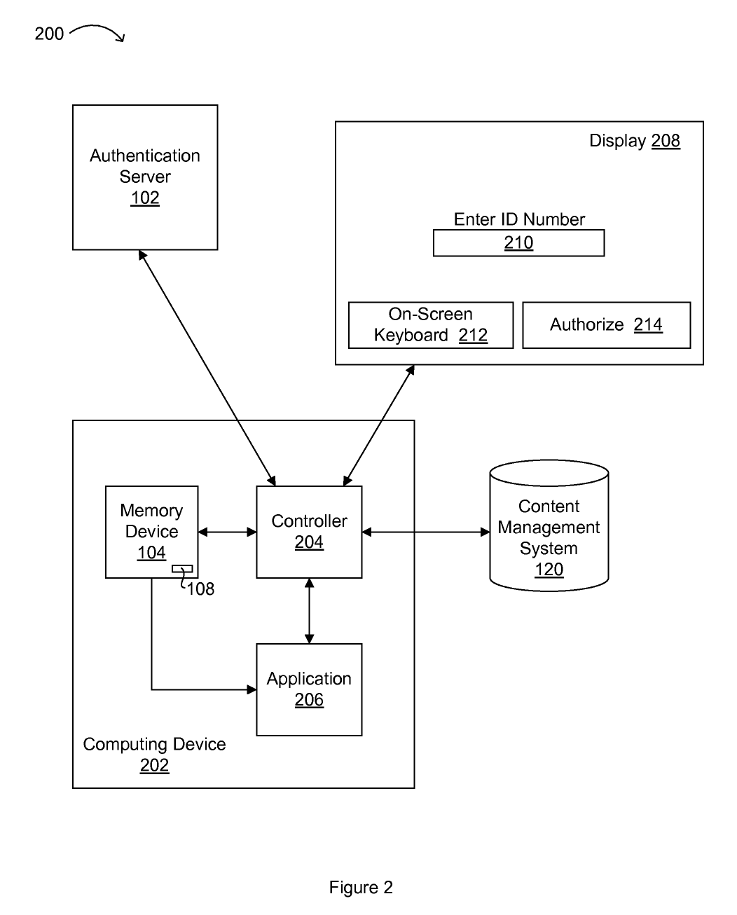

FIG. 2 depicts an example computing device and user interface for authentication arrangement 200. When a memory device 104 is inserted in computing device 202, such as via a USB interface, or any other suitable interface that allows for memory device 104 to be removably coupled (e.g., connected to, but removable from so as to be portable) to computing device 202, application 206 can be activated via controller 204. Computing device 202 can be any suitable type of computing device (e.g., personal computer, laptop, tablet, smart phone, etc.).

Application 206 can include a program that may be at least partially stored on memory device 104. In some cases, additional program code or updates can be downloaded via the Internet to supplement or override application 206. In any event, application 206 may be used to provide or supplement a template for presenting preloaded content from memory device 104. This template may be supplemented with personalized information, such as the name of the user, by application 206 accessing unique identifier 108 on memory device 104. In this fashion, application 206 may work in conjunction with controller 204 in order to provide initial access to the preloaded content and personalized information for a user, and this may be done in advance of a full authentication of memory device 104 (e.g., via authentication server 102).

In order to access more detailed customized content from content management system 120, memory device 104 may be authorized. Memory device 104 inserted in computing device 202 can be authorized using controller 204. Controller 204 can be a microcontroller unit (MCU), a general-purpose processor, a microprocessor, a central processing unit (CPU), or any other suitable type of controlling device. For example, controller 204 can interface with authentication server 102 in order to determine if memory device 104 is valid and/or a user of the content on the memory device is authenticated. Application 206 can also facilitate this authentication process in some embodiments.

In the example display 208, an entry 210 can be used to enter an identification number for computing device 202 and/or memory device 104. On-screen keyboard 212 is one option for entering information, and authorize 214 can be selected when the user is ready to send information and have authentication server 102 attempt authorization. For example, before this particular screen may be shown on display 208, content management system 120 associated with (or included within) authentication server 102 may perform a check of computing device 202 (e.g., Internet protocol (IP) address, geographic location, etc.) against a predetermined list in a database. In one particular example, an identifier for memory device 104, which may be the same or different than unique identifier 108, can then be entered (e.g., via entry 210). For example, this information entered via entry 210 may be used by content management system 120 to confirm delivery of the memory device against the IP address of computing device 202, or another suitable identifier of the user of computing device 202, versus an intended delivery address for memory device 104.

Once computing device 202 has downloaded (or is instructed to execute the current) authentication application, which may be part of application 206 or may be a different application, a key exchange may performed to verify that memory device 104 is valid. For example, computing device 202 may send a unique identifier and/or authentication key to server 102. The validation can also be accomplished via an authentication key exchange and verification process between the application executing on computing device 202 and authentication server 102. In response, authentication server 102 may send a valid indication to computing device 202.

In some cases, additional levels of authorization or security may be accommodated. For example, if memory device 104 is found to be valid by authentication server 102, a screen can be displayed in association with computing device 202 to provide instructions for the user to enter additional information to prove that they are an authorized user of memory device 104. In response, the user can enter authorized user information for sending to authentication server 102. In this portion, the user may be asked to enter an external (e.g., off-device, off-line, etc.) piece of information (e.g., via entry 210) to verify that the user is the intended recipient of the memory device. For example, such user verification information can include a number, a piece of text, a combination of text and numbers (alphanumeric characters), as well as speech recognition for voiceprint or voice characteristic analysis and matching, biometric matching, fingerprint matching, or any other suitable way of identifying a particular user. Authentication server 102 may then provide an indication as to whether this user is authorized to access customized content using memory device 104 on computing device 202.

An example whereby a computing device may refuse access is where content management system 120 associated with authentication server 102 for verification determines that unique identifier 108 returned by memory device 104 is not valid. In such a case, the unique identifier received (which might have been somehow tampered with in this example) may not match any corresponding number stored in a database entry, such as unique ID 108 in entry 106. Another example is where the key exchange process might not complete or might otherwise indicate some form of tampering.

Another example whereby a computing device may refuse access is where the content management system 120 associated with authentication server 102 for verification determines that memory device 104 may have been set to only access once, and that session has already taken place. For example, each requested access for a certain memory device identified by unique identifier 108 can be compared against a corresponding number stored in a database entry, such as in entry 106. Thus, if the number of requested accesses for a given memory device exceeds the stored number of allowed accesses, the memory device may be indicated as invalid, and access accordingly refused by computing device 202.

As discussed above, unique identifier 108 embedded on memory device 104 can be read by application 206. Application 206 may reside on memory device 104, on computing device 202, and may also be updated or supplemented via the Internet. For example, application 206 can include a video for playback via a multimedia tool, such as an Adobe Flash player. For example, application 206 can be running a Flash multimedia tool with a unique library, and can read unique identifier 108 and determine therefrom, e.g., a first name of the user, a segment group to which the user belongs, etc., and thus bring in a particular interface. In this fashion, between memory device 104 and application 206 running on controller 204 and/or memory device 104, personalized information can be relatively quickly presented to a user upon connecting memory device 104 to computing device 202. Once the user is engaged with the personalized message, the user may click and go online to authenticate memory device 104. Once this authentication is achieved, further customized content or information can be provided to the user, or the user can be redirected to another website for additional details targeted to the user via unique identifier 108.

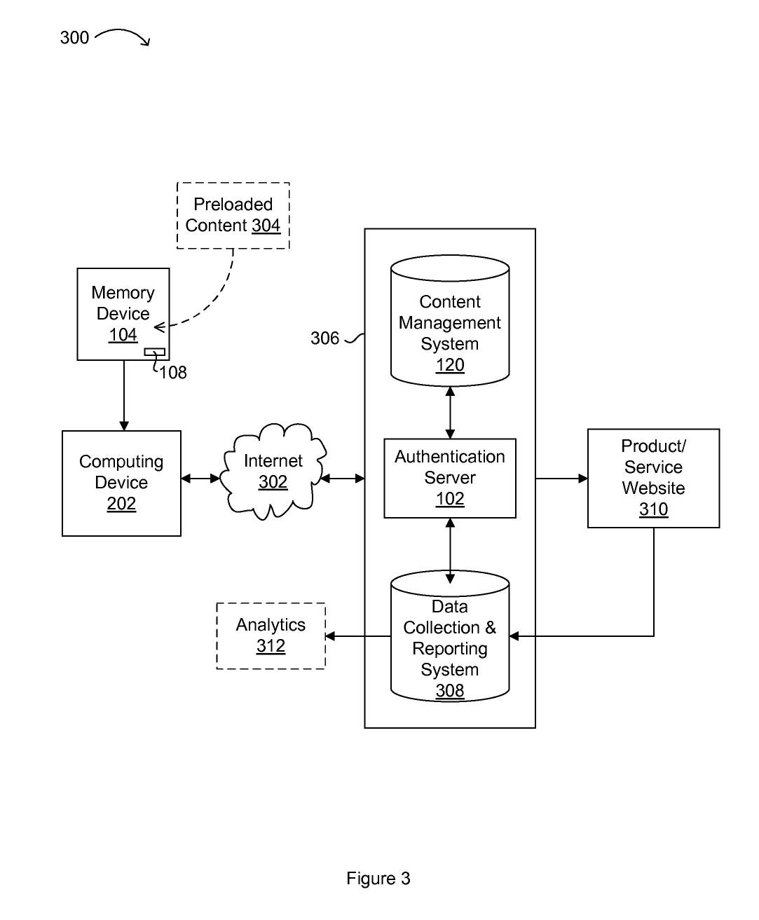

Referring now to FIG. 3, shown is an example data flow 300 to deliver customized content. Memory device 104 can contain preloaded content 304, as well as unique identifier 108. For example, preloaded content 304 can include one or more of program content (e.g., one or more instructions), branding information, product/service information, video (e.g., about products or services), call-to-action/offer information, an opt-in message if personalized information is collected, terms of service, and a privacy policy. Memory device 104 can be removably coupled (e.g., via a USB interface) to computing device 202, which may be an Internet capable device for interfacing via Internet 302.

Centralized server system 306 can include authentication server 102, which can interface with content management system 120, and data collection and reporting system 308. For example, unique identifier 108 can be received from computing device 202 via Internet 302, and a table lookup of content management system 120 can be performed by deriving a search key from the unique identifier. Based on a result of this lookup, specific and variable content/information and links can be provided via Internet 302 to computing device 202.

Direct links can be provided to a user as part of the customized content, such as links to product/service website 310. For example, partner sites may be coupled to product/service website 310 so that a user may be able to click on a direct link in order to access products or services via product/service website 310 and/or the partner sites. In another example, partner sites may also be coupled via authentication server 102 and/or content management system 120. Business rules and/or additional parameters as desired may be provided from product/service website 310 to data collection and reporting system 308. For example, business rules can include various collected parameters suitable for client requirements discussions.

This integration with web-services can achieve multiple goals. The fulfillment of variable programming can be enabled through a variety of strategies. Also, the physical component (e.g., memory device) can be tied to the Internet to further facilitate the development of the customer-to-company relationship. In addition, the unique identifier embedded in memory device 104, together with authentication, can enable business intelligence, such as for the further refinement, delivery, and improvement of product messaging and services offerings, by measuring the activation rate for a title or segment group. Therefore, costs to create and distribute program content on this media can be kept down, as memory device (e.g., flash memory) content may be mass produced, uniquely identified, then modified through a back-office infrastructure.

Flash, as well as other suitable nonvolatile, memory devices are increasingly being used in the fields of direct marketing, direct mail, pharmaceutical and healthcare, as a means to communicate rich interactive and multimedia information through a physical mechanism. The content and functionality of the programs loaded onto these devices may ultimately be aimed to deliver the recipient to a predefined customer product or service web-service.

Making data more relevant by way of the unique identifier at local personalized information, may help point the user toward wanting to access additional customized content. Once the user clicks and goes through authentication server 102, the unique identifier can tell that the user is in a particular ZIP code range, and as such can be provided market-specific information, and location information, such as the nearest car dealership, as part of the customized information. Such a deeper level of information like localized location-based customized content can be determined based on content management system 120 and unique identifier 108 upon authorization. For example, a person in a certain region can be shown one offer over another offer based on unique identifier 108.

Data collection and reporting system 308 can also provide analytics 312. For example, analytics 312 can include one or more of a unique engagement count, repeat engagement count, segment/ZIP code response, content usage metrics, link activity, time/date stamps, geo-targeting, as well as metrics from partner sites (e.g., whether an offer has been redeemed). Analytics 312 may be accessible by or downloadable to computing device 202 via Internet 302. In addition, certain embodiments can allow for programming or selecting various metrics to be included in analytics 312. Thus, partners and/or users may define which metrics or parameters are to be followed and tracked as part of analytics 312.

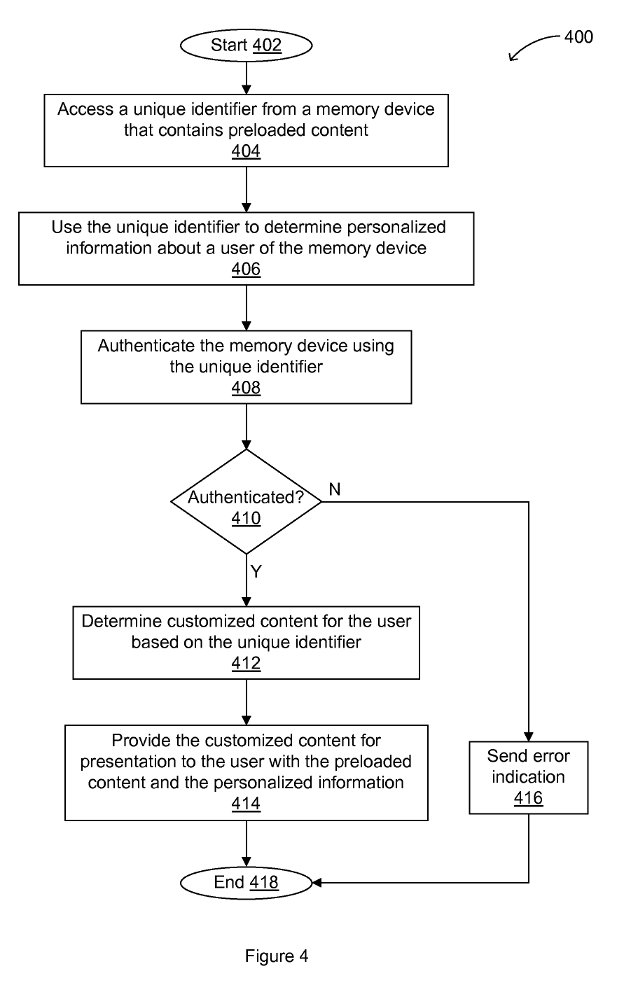

Referring now to FIG. 4, shown is a flow diagram of an example method 400 of delivering customized content. The flow begins at 402, and at 404 a unique identifier can be accessed from a memory device that contains preloaded content. For example, the memory device can be removably coupled to a computing device. At 406, the unique identifier can be used to determine personalized information about a user of the memory device. For example, application 206 can run to allow such personalized information to supplement a template from the preloaded content on the memory device.

At 408, the memory device can be authenticated using the unique identifier. Such authentication can allow for customized content in addition to the personalized information to be accessed by the user. If the memory device and/or user is not authenticated (410), an error indication can be sent at 416, and the flow may complete at 418. However, if the memory device is authenticated (410), customized content for the user can be determined based on the unique identifier at 412. As discussed above, such authentication can be performed via authentication server 102, and may include additional levels of security or authorization steps, such as having the user enter information not found on the memory device.

At 414, the customized content can be provided for presentation to the user with the preloaded content and the personalized information, and the flow may complete at 418. For example, the preloaded content can include a template that can be supplemented with personalized information (e.g., determined via the unique identifier by application 206) and customized content determined by content management system 120 utilizing unique identifier 108.

The customized content can also utilize segmentation codes to define and target offers, measure response to offers and the offer-design, and/or to deliver personalized information, such as for controlling one-to-one segmentation. For example, a healthcare company can use memory device 104 (e.g., an OTP device) to deliver a physical package containing their branding and their product or service message on the package, and also containing digitized information (e.g., a video message and specific details on a health plan or prescription drug) on the memory device (e.g., a flash device). This flash device can be inserted into the recipient's computer or tablet, and in response the multimedia application interface may be opened and viewed.

This overall template information can also be modified with unique information based on the unique identifier written to memory device 104. This unique information may include personalization within the user interface, a specific offer based on segment group, and/or specific URL routing based on the authentication of that segment group identifier, such as to a local or area representative, based on a ZIP code match-back to unique identifier 108.

In this way, unique identifier 108 can be used with a server (e.g., authentication server 102 and content management system 120) to provide detailed personalization or customized content information. Further, a local or initial personalization based on a coding technique in the unique identifier, such as a read back of a first name, can be applied via application 206. For example, “Welcome Bill” or “Here is your new red car” can be supplied based on information embedded in the unique identifier. This initial personalized information message may cause the user to want to click on a certain link for further information. For example, a Huffman coding technique can be utilized via the unique identifier to determine the personalized information or market segmentation. Thus, particular embodiments support a unique identifier with embedded meaning, and that may not be strictly serialized.

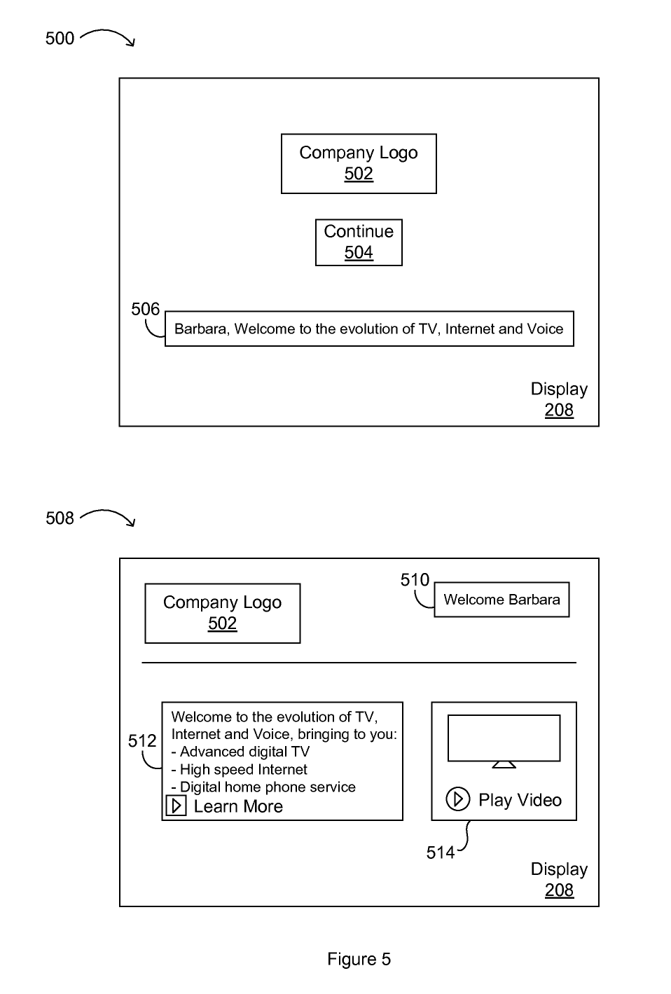

Referring now to FIGS. 5, 6, and 7, shown are various example interface presentations of customized content with preloaded content and personalized information. In FIG. 5, example 500 shows display 208 having company logo 502, a continue button 504, and a personalized message 506. Example 508 shows the company logo 502, a personalized “Welcome Barbara” message 510, which may represent such initial personalized information, as well as call-to-action messages 512 and 514. Call to action message 512 allows for clicking to learn more about the offerings provided, and call-to-action message 514 allows for the playing of a video.

In this fashion, dynamic content, such as the personalization and specific channel call-to-action message, may be driven by the unique identifier within the memory device, and delivered into a template interface. The application template can be fed with dynamic content that is personalized to the recipient of a segment group. In this example, a relatively simple interface is used. However, the memory device can contain multimedia programming, such as a flash demonstration or video program, and multiple URL links. For example, when the USB recipient elects to continue or learn more, the user is directed to the relevant location online that has been defined by their segment group based on the unique identifier.

Unique identifier 108 may be authenticated and redirected to enable a personalized greeting or offer on the customer website, and/or to enable specific offers based on recognition of the segment group. In this example, a screen grab representing more detailed information as relevant to the segment group assigned to the application or identifier code embedded on that particular USB-based memory device can be provided. In addition, the system can be used to support personalization and unique information within the online landing page when integrated with a web services strategy.

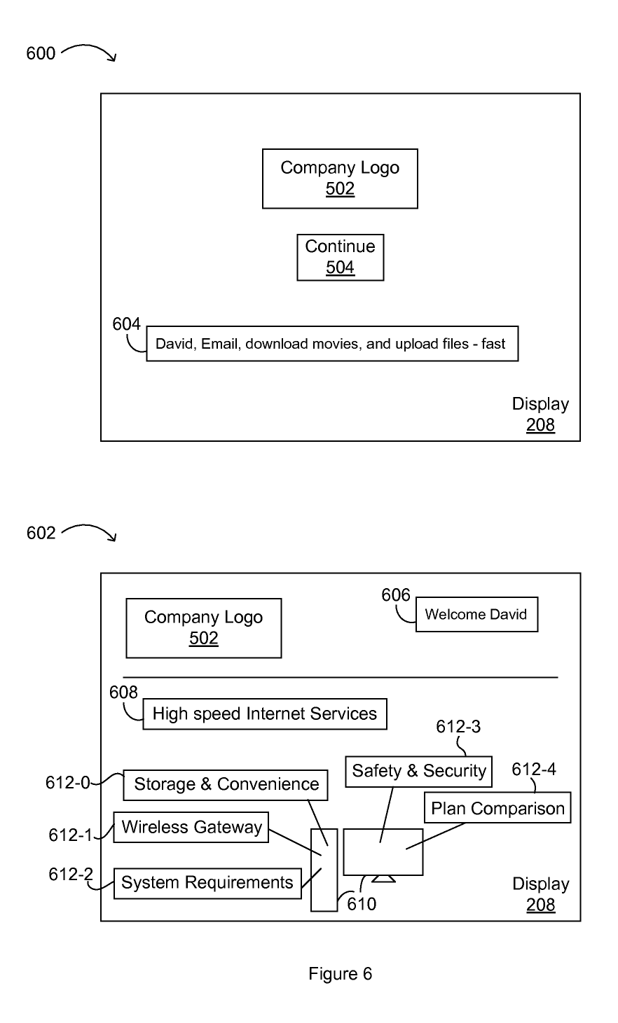

In example 600 of FIG. 6, personalized information 604 can include information directed to user “David.” Example 602 of this plate 208 can include personalized message “Welcome David” 606, as well as several direct links for accessing additional customized information or content about high-speed Internet services 608. For example, direct links 612 can include direct link 612-0 for storage and convenience, direct link 612-1 for wireless gateway, direct link 612-2 for system requirements, direct link 612-3 for safety and security, and direct link 612-4 for plan comparison. Direct links 612 can reference various objects in the presentation, such as computer objects 610.

In particular embodiments, cross sell offers may be titled-based on the title of something (e.g., Smurfs), which can be determined based on the unique identifier. As such, the personalization may be based on the title of the content (e.g., preloaded content or customized content). As discussed above, authentication can allow for determination of customized content, and also allow for generation of analytics and reporting (e.g., analytics 312). Alternatively, different projects may utilize a local content management system. However, one or more centralized servers (e.g., 306) can manage the content and the customization can be based on the interactions (e.g., titles) with content management system 120. Some approaches may also utilize a hardcoded link specific to that title.

Segmentation codes may define different authors or different market segments for products and services. For example, preloaded content 304 can be generic across the run of product, but unique identifier 108 can allow for differentiation to support customized content. For example, when a user interacts with that content, a part of the unique identifier code might tell server 306 that the user is from Rhode Island. Using this information, specific laws related to Health Insurance Portability and Accountability Act (HIPPA) compliance, such as laws that may be unique to the particular state of Rhode Island, can be determined to provide the appropriate information based on this location. Thus, such segmentation codes may be embedded or programmed in the unique identifier. Flexibility as to determining and assigning the unique identifier to memory device 104 can accommodate working with customers to define a particular identifier or code. For example, the unique identifier can be determined based on a business model considering what the customers need for that particular business.

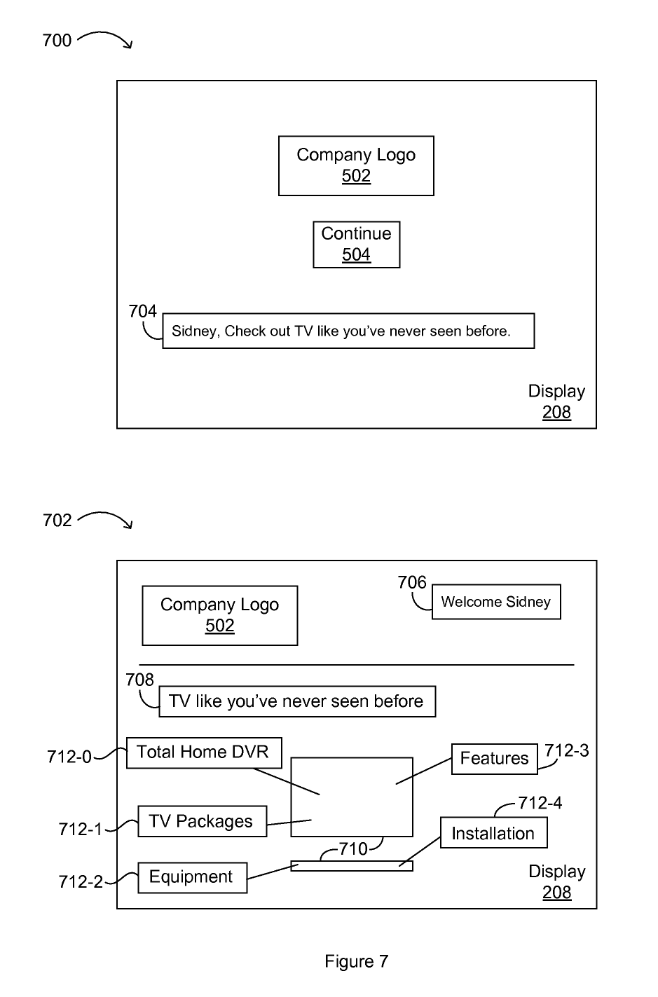

In example 700 of FIG. 7, personalized information can include message 704 directed to “Sidney” related to TV services. Example 702 shows on display 208 a “Welcome Sidney” message 706, and various links 712 to information related to description 708. For example, direct link 712-0 can include information about total home digital video recorder (DVR), direct link 712-1 is for TV packages, direct link 712-2 is for equipment information, direct link 712-3 is for features, and direct link 712-4 is for installation information. Direct links 712 can reference various objects, such as TV equipment objects 710. For example, direct links 712 can allow access directly to a company website corresponding to company logo 502.

Particular embodiments are suitable to a variety of products and services. For example, particular embodiments can be applied to the direct mail industry. The United States Postal Service (USPS) delivered 201 billion pieces of direct mail in fiscal 2008. However, the USPS is seeing a steady decline in mail delivered, as it is competing for attention due to the growth of the Internet as an advertising medium. The USPS has set its strategy to include physical to web integrations in its Strategic 5 Year Plan for 2009-2013.

Particular embodiments can support designs of web-based services and new applications for mail. Also, mail may be integrated with online services and multimedia campaigns. In addition, mailing and shipping services can be designed to complement the Internet, thus taking advantage of the demonstrated effectiveness of mail in driving customers to web sites and increasing revenue. Further, the introduction of web-based services can facilitate expanded access and also create new applications for mail.

Particular embodiments can be utilized in direct mail marketing, whereby segmentation (e.g., via a unique identifier 108) can be used for variable messaging and offers together with personalization within the user interface, or within the delivery of such offers.

Particular embodiments can also be utilized in pharmaceutical applications. For example, doctors can pass a packaged OTP memory device to patients containing prescription, diagnosis, and/or frequently asked questions (FAQs). These can be tied to specific doctors, offices, hospitals, so that pharmaceutical companies can verify the delivery of critical communications regarding its medications is being activated and viewed by the patient.

Particular embodiments can also be used in healthcare applications. For example, delivery of insurance, health maintenance organization (HMO) health-plan and membership information, with activation or renewal information and direct links to the healthcare company. Unique identifiers may be used to support the delivery of variable content to the relevant segment group.

Other aspects of the medical field, such as HIPPA compliance, can also be supported in particular embodiments. For example, adherence to government regulations as to pharmaceuticals, etc., without the ability to be modified, can be accommodated by using an OTP type of memory device. Further, user identifier 108 can be used for referrals to medical providers, with authentication allowing for secure transmission of medical referrals, tracking, and patient information. As such, initial personalized information can be employed for referrals to medical providers, but authentication would allow for customized content, such as medical diagnoses, prescriptions specific to a patient or user, or any other suitable medical information.

Particular embodiments can also be utilized in entertainment media applications. For example, certain embodiments can provide an alternative media option to compact disc (CD) and digital video disc (DVD) media.

Particular embodiments can also be utilized in event-based marketing. For example, OTP or flash memory may contain information about a company, product or service, such as a university or automobile, and can be distributed at recruiting events, auto-shows, dealerships, etc.

Particular embodiments can also be utilized in financial services. For example, prospectus and financial planning information can be securely distributed and validated to ensure that the particular content has been activated and/or viewed by a user.

Particular embodiments can also be utilized in corporate training applications. For example, remote employee and sales agent training can be accommodated, where the memory devices contains training materials in multiple languages to accommodate each employee and/or sales agent locale as appropriate. In this fashion, a company can track and determine that the training materials are being viewed, e.g., by the global/remote sales agents of the company.

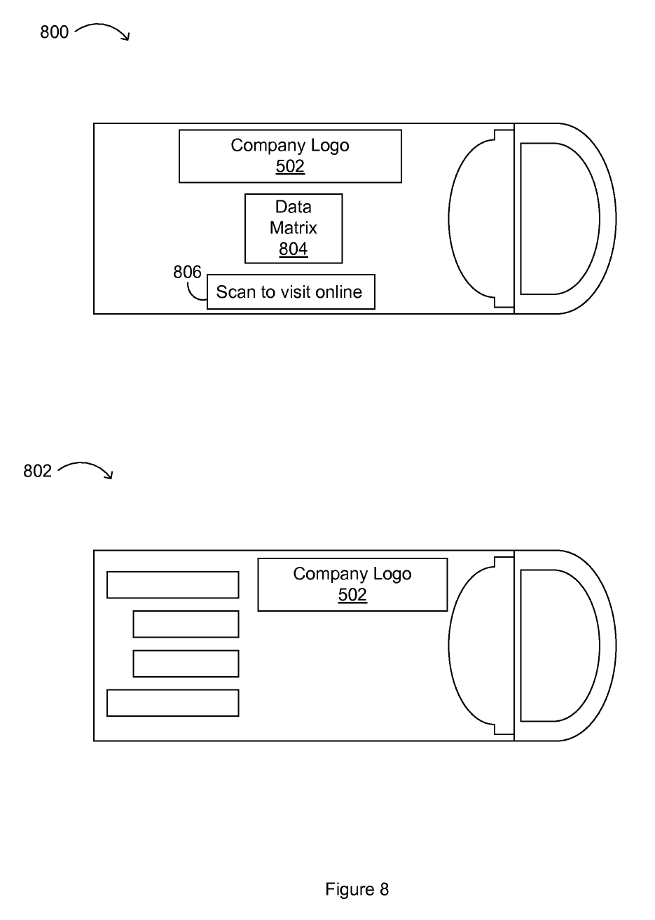

Referring now to FIG. 8, shown is an example memory device physical shell. Of course, any variety of physical shells and possible form factors can be employed in accordance with particular embodiments. In this particular example, variable data printing can be utilized to apply unique codes and human readable information to the USB label of each USB device. This visual information can be used to associate segment groups to a particular marketing channel, or for one-to-one match-backs in direct marketing applications. In this fashion, a number of physical to digital channel strategies can be enabled when integrated together with various web services.

A variable print message area can also be used on a casing of the example memory device, such as shown in frontside view 800. For example, a data matrix code 804 with messaging (e.g., scan to visit online message 806, company logo 502, etc.) can be applied. The print may be supported with a unique variable data printing process to enable each manufactured USB to receive a unique data matrix, quick response (QR) code, human readable serial code, and/or text personalization. This allows for visual association or assignment to specific channel segments, or for direct mailing applications. The USB form factor may also be configurable, and an example reverse side view is shown in 802. As discussed above, certain embodiments are amenable to a wide variety of physical shell or package types (e.g., panel packages with swing arms, buckslip, tri-fold, full page, credit-card like packages, etc.).

Thus as described herein, an approach for delivery of content management and analytics, and a process utilizing unique identifiers of memory devices that can be removably coupled to a computing device, can allow for customized content management.

Although the description has been described with respect to particular embodiments thereof, these particular embodiments are merely illustrative, and not restrictive.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program, instructions, and/or code that can be stored in a machine-readable medium to permit a computer to perform any of the methods described above.

A “processor” includes any suitable hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems. A computer may be any processor in communication with a memory. The memory may be any suitable processor-readable storage medium, such as random-access memory (RAM), read-only memory (ROM), magnetic or optical disk, or other tangible media suitable for storing instructions for execution by the processor.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A method of delivering content, the method comprising:
accessing a unique identifier from a memory device that is removably coupled to a computing device, wherein the memory device comprises the unique identifier and preloaded content;
using the unique identifier to determine personalized information about a user of the memory device;
authenticating the memory device by using the unique identifier from the memory device;
determining customized content for the user if the memory device is authenticated, wherein the customized content is based on the unique identifier; and
providing the customized content for presentation to the user along with the preloaded content and the personalized information.

2. The method of claim 1, wherein the using the unique identifier to determine the personalized information comprises using an application that is loaded onto the computing device.

3. The method of claim 2, wherein the unique identifier is chosen such that the personalized information is derivable from the unique identifier by using the application.

4. The method of claim 1, wherein the using the unique identifier to determine personalized information comprises:
receiving the unique identifier from the computing device; and
performing a table lookup on a content management system by deriving a search key from the unique identifier.

5. The method of claim 1, wherein the authenticating the memory device comprises sending the unique identifier to an authentication server.

6. The method of claim 1, wherein the authenticating the memory device comprises:
receiving an authentication code from the user via the computing device, wherein the authentication code is not stored on the memory device; and
matching the authentication code with a code corresponding to the unique identifier.

7. The method of claim 1, wherein the memory device is removably coupled via a universal serial bus (USB) connection.

8. The method of claim 1, wherein the memory device comprises at least one of: one-time programmable (OTP) memory and reprogrammable non-volatile memory.

9. The method of claim 1, wherein the preloaded content on the memory device comprises an application template configured to be supplemented with the personalized information and the customized content.

10. The method of claim 1, wherein the customized content comprises at least one of: healthcare information for the user, personalized direct mail offers for the user, pharmaceutical information for the user, and event-based marketing information for the user.

11. An apparatus configured to deliver content, the apparatus comprising:
one or more processors; and
a computer-readable storage medium having one or more instructions stored thereon for execution by the one or more processors, and when executed being operable to perform:
accessing a unique identifier from a memory device that is removably coupled to a computing device, wherein the memory device comprises the unique identifier and preloaded content;
using the unique identifier to determine personalized information about a user of the memory device;
authenticating the memory device by using the unique identifier from the memory device;
determining customized content for the user if the memory device is authenticated, wherein the customized content is based on the unique identifier; and
providing the customized content for presentation to the user along with the preloaded content and the personalized information.

12. The apparatus of claim 11, wherein the using the unique identifier to determine the personalized information comprises using an application that is loaded onto the computing device.

13. The apparatus of claim 12, wherein the unique identifier is chosen such that the personalized information is derivable from the unique identifier by using the application.

14. The apparatus of claim 11, wherein the using the unique identifier to determine personalized information comprises:
receiving the unique identifier from the computing device; and
performing a table lookup on a content management system by deriving a search key from the unique identifier.

15. The apparatus of claim 11, wherein the authenticating the memory device comprises sending the unique identifier to an authentication server.

16. The apparatus of claim 11, wherein the authenticating the memory device comprises:
receiving an authentication code from the user via the computing device, wherein the authentication code is not stored on the memory device; and
matching the authentication code with a code corresponding to the unique identifier.

17. The apparatus of claim 11, wherein the memory device is removably coupled via a universal serial bus (USB) connection.

18. The apparatus of claim 11, wherein the memory device comprises at least one of: one-time programmable (OTP) memory and reprogrammable non-volatile memory.

19. The apparatus of claim 11, wherein the preloaded content on the memory device comprises an application template configured to be supplemented with the personalized information and the customized content.

20. A system for delivering content, the system comprising:
means for accessing a unique identifier from a memory device that is removably coupled to a computing device, wherein the memory device comprises the unique identifier and preloaded content;
means for using the unique identifier to determine personalized information about a user of the memory device;
means for authenticating the memory device by using the unique identifier from the memory device;
means for determining customized content for the user if the memory device is authenticated, wherein the customized content is based on the unique identifier; and
means for providing the customized content for presentation to the user along with the preloaded content and the personalized information.
